(19) United States
(12) Patent Application Publication
(10) Pub. No.: US 2025/0109272 A1
(43) Pub. Date: Apr. 3, 2025

(54) CORE-SHELL STRUCTURE-DIRECTING AGENTS

(71) Applicant: UNIVERSITY OF SOUTH CAROLINA, COLUMBIA, SC (US)

(72) Inventors: MORGAN STEFIK, COLUMBIA, SC (US); TAYLOR LARISON, MONROE, OH (US)

(21) Appl. No.: 18/776,384

(22) Filed: Jul. 18, 2024

Related U.S. Application Data
(60) Provisional application No. 63/587,460, filed on Oct. 3, 2023.

(51) Int. Cl. C08K 3/22; C08F 299/02

(52) U.S. Cl. CPC C08K 3/22; C08F 299/024; C08K 2003/2237; C08K 2003/2244; C08K 2201/011

(57) ABSTRACT

Disclosed herein are methods for forming a heterostructure including a matrix and pores disposed therein with different elemental compositions. The method generally sequential addition of metal oxide nanoparticles to block copolymer micelles which are capable of persistently binding metal oxide nanoparticles.

### CROSS REFERENCE TO RELATED APPLICATION

This application claims filing benefit of U.S. Provisional Patent Application Ser. No. 63/587,460 having a filing date of Oct. 3, 2023, which is incorporated herein by reference for all purposes.

### FEDERAL RESEARCH STATEMENT

This invention was made with Government support under Contract No. DMR-1752615, awarded by the National Science Foundation. The Government has certain rights in the invention.

### BACKGROUND

Porous materials are useful for the manufacture of solar cells, batteries, tandem catalysts, and more. As such, there is a large need for a means to produce materials with heterostructures with methods that are scalable and cost-effective. However, manufacturing inorganic heterostructures can be difficult. For instance, while nature has adapted the ability to form inorganic nanostructures in an organic matrix via biomineralization, no such equivalent exists for inorganic nanostructures within inorganic matrices.

In order to make heterostructures, the state of the art is to use additive manufacturing techniques, such as stereolithography. However, these techniques have disadvantages such as high cost, high processing time and high material waste.

### SUMMARY

As will be demonstrated through the following description, the inventors of the present disclosure have developed a means to form heterostructures without additive manufacturing. Instead, the present application describes the manufacture of heterostructures using structure-directing agents for a facile process of self-assembly.

The present disclosure is directed to a method for producing an inorganic heterostructure comprising the steps of forming a solution comprising block copolymer micelles, adding first metal oxide nanoparticles to the solution, wherein upon the addition, functional groups of the block copolymer micelles react with the first metal oxide nanoparticles to covalently bond the first metal oxide nanoparticles to the block copolymer micelles, and adding second metal oxide nanoparticles to the solution.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1A is a schematic of nanoparticles aggregating outside of a dynamically-binding polymer micelle.

FIG. 1B is a comparative ¹H NMR of the polymer micelle compared to the ¹H NMR of the filtrate post aggregation.

FIG. 2A is a schematic of nanoparticles aggregating inside of a persistently-binding polymer micelle.

FIG. 2B is a comparative ¹H NMR of the polymer micelle compared to the ¹H NMR of the filtrate post aggregation.

FIG. 3A is a schematic of how ordered addition affects nanoparticle distribution within a persistently-binding polymer micelle.

FIG. 3B is an elemental composition scan of a nanostructure created by the calcination of a polymer micelle solution comprising the solution shown in FIG. 3A.

FIG. 3C is a graph of intensity per element by position. Each element (niobium, titanium) has a varying distribution, corresponding to the core-shell structure shown in FIG. 3A.

FIG. 4A is a schematic of how dynamic mixing affects nanoparticle distribution within a dynamically-binding polymer micelle.

FIG. 4B is an elemental composition scan of a nanostructure created by the calcination of a polymer micelle solution comprising the solution shown in FIG. 4A.

FIG. 4C is a graph of intensity per element by position. Each element (niobium, titanium) has a homogenous distribution, corresponding to the core-shell structure shown in FIG. 4A.

FIG. 5A is a schematic of one exemplary order of addition to a persistently-binding polymer micelle. FIGS. 5B and 5C are elemental composition scans of a nanostructure resulting from the calcination of a polymer micelle solution as described in FIG. 5A.

FIG. 6A is a schematic of one exemplary order of addition to a persistently-binding polymer micelle. FIGS. 6B and 6C are elemental composition scans of a nanostructure resulting from the calcination of a polymer micelle solution as described in FIG. 6A.

FIG. 7A is a schematic of one exemplary order of addition to a persistently-binding polymer micelle. FIGS. 7B and 7C are elemental composition scans of a nanostructure resulting from the calcination of a polymer micelle solution as described in FIG. 7A.

FIG. 8A is a schematic of one exemplary order of addition to a persistently-binding polymer micelle. FIGS. 8B and 8C are elemental composition scans of a nanostructure resulting from the calcination of a polymer micelle solution as described in FIG. 8A.

FIG. 9A is a schematic of a di-block polymer micelle solution. FIG. 9B is a SEM image of a calcined polymer micelle solution as shown in FIG. 9A.

FIG. 10A is a schematic of a terpolymer micelle solution. FIG. 10B is a SEM image of a calcined polymer micelle solution as shown in FIG. 10A.

FIG. 11A is a schematic of ordered addition of nanoparticles to a terpolymer micelle. In this embodiment, not enough time has elapsed to allow the first nanoparticles to become persistently bound to an inner hydrophilic shell. FIG. 11B is an elemental composition scan of a calcined micelle solution comprising as made by the schematic in FIG. 11A. As can be seen in FIG. 11B, there is a homogenous distribution of the nanoparticles.

FIG. 12 is a schematic demonstrating the process of ordered addition, agitation and elapsed time which is useful for persistently binding the first added nanoparticles before the addition of the second nanoparticles.

FIGS. 13A-13D are images generated from elemental composition scans and small angle X-ray scattering scans of a calcined polymer micelle solution as made by the process shown in FIG. 12.

FIGS. 14A-14C are summary data regarding the pore characteristics of the calcined samples shown in FIGS. 13A-13D. FIG. 14A is a graph depicting the quantity of nitrogen adsorped by the nanostructure compared to the pressure of nitrogen applied. FIG. 14B is a graph of the mesopore size distribution in a heterostructure. FIG. 14C is a graph of the log intensity of scattered rays relative to the momentum transfer, q.

FIGS. 15A-15C are schematics showing possible conditions created by undersaturation of nanoparticles, saturation of nanoparticles, and oversaturation of nanoparticles. In FIG. 15A, nanoparticles become persistently bound to multiple polymer micelles. In FIG. 15B, nanoparticles are persistently bound to one polymer micelle. In FIG. 15C, nanoparticles are oversaturated in the solution, and remain largely unbound by any polymer micelle.

FIG. 16 is a graph showing the polymer micelle concentration relative to the nanoparticle to polymer mass ratio. In this graph, triangles represent unstable solutions, wherein the polymer micelles precipitate from the solution, and circles represent a stable solution.

FIG. 17 is a graph of the log intensity of scattered rays relative to the momentum transfer, q, of varying nanoparticle to polymer mass ratios. The lines appear in the graph as in the order in the legend.

FIG. 18 is a table showing the individual polymers which made up an exemplary diblock polymer micelle and their characteristics, such as molar mass, dispersity, and molar mass dispersity.

FIG. 19 is a table showing the individual polymers which made up an exemplary triblock polymer micelle and their characteristics, such as molar mass, dispersity, and molar mass dispersity.

FIG. 20 is a graph showing the % number of pores with a given hydrodynamic pore size for the calcined diblock polymer micelle solution.

FIG. 21 is a graph showing the % number of pores with a given hydrodynamic pore size for the calcined triblock polymer micelle solution.

FIG. 22A is a schematic showing the migration of nanoparticles added to a triblock polymer micelle solution from the outer hydrophilic shell to the inner hydrophilic shell, where the nanoparticles become persistently bound.

FIG. 22B is a comparison of SEM images taken of calcined samples before and after the nanoparticles were allowed to migrate to the inner hydrophilic shell of the triblock polymer micelle.

FIG. 23 is a schematic and graph showing the nanostructure created when nanoparticles are added to the triblock polymer micelle, and undergo calcination without any agitation/migration.

FIG. 24 is a schematic and graph showing the nanostructure created when nanoparticles are added to the triblock polymer micelle, and undergo calcination with 40 hours of agitation. any agitation/migration.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to self-assembling heterostructures. These nanostructures are useful in a broad range of applications, including but not limited to, solar cells, batteries, and catalysts.

As used herein, the term “SDA” shall refer to “structure-directing agents.” Such structure-directing agents, while not particularly limited, include PS-b-PEO, PCHMA-b-PMMPA and PCHMA-b-PMMPA-b-PPEGMA. The above-listed structure-directing agents may also be termed as block copolymers. Block copolymers, for the purposes of the present invention are copolymers which comprise distinct “blocks” which are different polymers. Structure-directing agents allow for the self-assembly of structures, typically with some element of regularity. For instance, in the present application, structure-directing agents are used in the formation of block copolymer micelles that allow the for the formation of a porous network in an inorganic material with a uniform spatial distribution. In the present application, copolymer micelles are regarded as structure-directing agents, as they lead to the formation of a regular, porous structure.

As used herein, the term “persistently bound” is understood to be in contrast to “dynamically bound.” Persistently bound means that a nanoparticle is bound to a polymer by an interaction of comparable strength to a covalent or ionic bond, and dynamically bound means that the interaction will continuously reform at room temperature.

Structure-directing agents (SDAs) have been used in forming dynamic nanoparticle-micelle structures. These structures make use of ethylene oxide group-bearing polymers to form weak, dynamic bonds with nanoparticles. However, these dynamically bound structures have shortcomings as recognized by the present inventors. Primarily, these dynamically bound structures lack the “memory” required to form heterostructures. That is, because the binding is dynamic, the order of addition of two different nanoparticles has no effect on the final nanoparticle distribution of the nanostructure-dynamic mixing occurs and a homogenous structure with little or no variation in nanoparticle distribution is created.

In the present disclosure, the term heterostructure is typically used to describe samples that involve a well-defined interface between two materials. The structure may additionally include porosity throughout. For instance, the pores of a nanostructure, which can be created by the copolymer micelles being “burned out” during the calcination step, can be defined by walls with an elemental composition that is distinct from the surrounding matrix (i.e., the bulk of the structure). As an example, referencing the ordered addition as described above, the inner walls of the pores may be rich in an element which is a component of the first metal oxide nanoparticles, and the matrix may be rich in an element which is a component of the second metal oxide nanoparticles.

The heterostructure as described above is made possible by the presence of chemical groups on a copolymer micelle that can persistently bind metal oxide nanoparticles. In contrast to copolymer micelles which are capable of persistently-binding, polymer micelles which are capable exclusively of dynamic binding are not able to produce heterostructures, as the nanoparticles will constantly bind and release from the micelle, thus erasing any history of the addition order of different types of nanoparticles. Functional groups fit for persistently binding nanoparticles include phosphonic acids, silanes, acetylacetonates, and carboxylates.

The disclosed method generally includes forming a solution of copolymer micelles which comprise a hydrophobic core polymer block and a hydrophilic shell polymer block, though in some embodiments, this may be reversed (i.e., a hydrophilic core and hydrophobic core). Thereafter, a first type of metal oxide nanoparticles may be added to the solution. The first metal oxide nanoparticles become persistently bound to the hydrophilic shell/core of the copolymer micelle. After the first metal oxide nanoparticles are added to the solution, second metal oxide nanoparticles are added to the solution. The second metal oxide nanoparticles may become either dynamically bound by the copolymer micelle, or remain as an unbound matrix. Following the addition of the second metal oxide nanoparticles, the solvent of the solution may be removed, for instance by evaporation. The sample is then aged, and calcined. Due to the persistent binding of the first metal oxide nanoparticles, the sequential addition of first and second metal oxide nanoparticles may be preserved in the nanostructure of the calcined sample.

More specifically, a present method generally includes first forming a solution of copolymer micelles. The copolymer of the micelles comprise at least two different polymers, also known as a diblock copolymer. A first block polymer can form the core of the micelle and is hydrophobic. A second block polymer can form the shell structure of the micelle and is hydrophilic and comprises groups that may persistently bind metal oxide nanoparticles. After the solution of copolymer micelles has been formed, a first type of metal oxide nanoparticle is added to the solution. These first metal oxide nanoparticles become persistently bound to the hydrophilic second block polymer of the copolymer micelle. Further, these first metal oxide nanoparticles may be added in an amount great enough to saturate the binding sites of the hydrophilic block polymer. Thereafter, the second metal oxide nanoparticles may be added to the solution. As the binding sites of the hydrophilic polymer block are occupied, the second metal oxide nanoparticles remain as an unbound matrix.

As a further embodiment of the present invention, the copolymer micelles may comprise a core and shell structure comprising polymers of three block, also known as a terpolymer or a triblock copolymer: a first block polymer which is hydrophobic, can form the core of the polymer as described above, a second block polymer which is hydrophilic can form a first part of the shell, a third block polymer which is hydrophilic can form a second part of the shell. The second block polymer may be differentiated from the third block polymer by the presence of chemical groups that may persistently bind nanoparticles, polymer type, length or molecular weight, or any combination thereof. Meanwhile, the third block polymer may comprise groups that dynamically bind metal nanoparticles. After the formation of a micelle as described above, first metal oxide nanoparticles may be added to the solution of copolymer micelles with the three-polymer structure. The first metal oxide nanoparticles may become persistently bound to the second block polymer of the copolymer micelle. Further, the metal oxide nanoparticles may be added in an amount sufficient to saturate the majority of the binding sites of the second block polymer. After the first metal oxide nanoparticles are bound to the copolymer micelles, second metal oxide nanoparticles may be added. As the binding sites which are capable of persistently-binding metal oxide nanoparticles are saturated with the first metal oxide nanoparticles, the second metal oxide nanoparticles may become dynamically bound to groups capable of dynamic binding.

Generally, polymer micelles are micelles formed of two or more polymer blocks. Depending on the solvent that they will be immersed in, the micelle may have a hydrophilic or hydrophobic core, and a shell that has the inverse hydrophilicity as compared to the core. For instance, if the micelle is to be placed/utilized in water, the core may be hydrophobic, whereas the shell may be hydrophobic. In contrast, if the micelle is to be placed/utilized in oil, or a hydrophobic solvent, the core may be hydrophilic, and the shell hydrophobic.

In one embodiment of the present disclosure, copolymer micelles may comprise a diblock polymer. The diblock polymer may comprise a hydrophobic core, and a hydrophilic shell. The hydrophobic core may comprise, but is not limited to, polystyrene, polyethylene, polypropylene or PCHMA. The hydrophilic shell may comprise PEG, PEO, PMAA or PPEGMA. Methods for synthesizing diblock copolymer micelles are described in more detail in Example 1. However, the method generally includes coupling a hydrophilic polymer to a hydrophobic polymer. Thereafter, the diblock copolymer is reacted with a reagent which causes the hydrophilic polymer to bear groups that are capable of persistently binding metal oxide nanoparticles.

Similarly, a triblock copolymer may comprise a hydrophobic core, and a hydrophilic shell. The hydrophobic core may comprise polystyrene, polyethylene, polypropylene or PCHMA. The first block polymer of the hydrophilic shell may comprise, but is not limited to, PMAA or PPEGMA. The second block polymer of the hydrophilic shell may comprise PDEPMA or a related polymer block with a suitable binding group such as a silane, carboxylate, or acetylacetonate. The second block polymer of the hydrophilic shell may act to dynamically bind metal oxide nanoparticles, such as through dipole-dipole interactions, or other small intermolecular forces.

The polymer blocks of a copolymer may each independently have molar masses of about 4000 g/mol or greater, such as about 7,500 g/mol or greater, such as about 15,000 g/mol or greater, such as about 25,000 g/mol or greater, such as about 35,000 g/mol or greater. Polymer blocks may each independently have a molar mass of about 35,000 g/mol or less, such as about 25,000 g/mol or less, such as about 15,000 g/mol or less, such as about 7,500 g/mol or less. Additionally, the first, second, and optionally third polymer blocks may have molar masses that are different from each other. For instance, in a triblock copolymer micelle, the hydrophobic core may be three times the molar mass of a persistently-binding hydrophilic shell, and 1.5 times the molar mass of a dynamically-binding hydrophilic shell.

The composition of the metal oxide nanoparticles is not particularly limited. While the present disclosure makes use of titanium oxide, niobium oxide and zirconium oxide, the present application may be applied to a much wider range of metal oxide nanoparticles, such as, and without limitation to, iron oxide, silver oxide, zinc oxide, cobalt oxide, nickel oxide, manganese oxide, copper oxide, chrome oxide, platinum oxide, lanthanum oxide, hafnium oxide, tungsten oxide, palladium oxide, ruthenium oxide and aluminum oxide, as well as any combination of metal oxide nanoparticles of metal chalcogenide nanoparticles (e.g. “quantum dots”).

In a further aspect of the present disclosure, the inventors have found that to obtain a heterostructure the addition of first nanoparticles can include wait period to allow the first nanoparticles a sufficient period of time to become persistently bound to the copolymer micelle before adding the second nanoparticle.

A sufficient period of time for the nanoparticle to diffuse and become bound to the copolymer micelle may depend on the density of the nanoparticle, the mass ratio of the micelle and the nanoparticle, the hydrophilic block architecture (comb vs linear polymer), and the concentration of the nanoparticles relative to the concentration of micelles in a copolymer micelle solution. Nonetheless, periods of time suitable for methods of the present disclosure can be greater than five hours, such as about 10 hours or greater, such as about 20 hours or greater, such as about 30 hours or greater, such as about 40 hours or greater, such as about 50 hours or greater, such as about 60 hours or greater. Additionally, time periods may be about 60 hours or less, such as about 50 hours or less, such as about 40 hours or less, such as about 30 hours or less, such as about 20 hours or less, such as about 10 hours or less, such as about 5 hours or less.

In one aspect of the present disclosure, the present inventors found that the concentration of micelles relative to the mass ratio of the nanoparticles to that of the polymer micelles can be used to predict the susceptibility of the nanoparticle-micelles to precipitate out of solution. It was found that at high concentrations of micelles, relatively high mass ratios between nanoparticles and micelles can form a stable solution. Conversely, low mass ratios between nanoparticles and micelles, such as mass ratios between 0 and about 0.2 can be prone to precipitation at a variety of micelle concentrations. For instance, the first nanoparticles may have a mass ratio with the micelles of about 0.50 or greater, such as about 0.75 or greater, such as about 1.00 or greater, such as about 1.25 or greater, such as about 1.50 or greater, such as about 1.75 or greater, such as about 2.00 or greater.

In another aspect of the present disclosure, the second nanoparticles may have a mass ratio with the micelles of about 0.5 or greater, such as about 1.0 or greater, such as about 2.0, or greater such as about 3.0 or greater, such as about 4.0 or greater. In other embodiments, the second nanoparticles may have a mass ratio with the micelle of about 4.0 or less.

Furthermore, various attributes, such as pore size and spacing, can be controlled prior to calcination through varying the block polymer micelle size by varying constituent block polymer sizes.

After the sequential addition of metal oxide nanoparticles and the formation of nanoparticle-bound micelles, the solvent of the micelle/metal oxide nanoparticles composites may be removed, such as through evaporation. After the sample has been dried, as desired, the sample may undergo aging and calcination.

Aging may be conducted at a variety of temperatures and for a variety of durations known to one of skill in the art. For example, aging may be conducted at temperatures greater than about 40° C. but less than about 150° C., such as greater than about 60° C. but less than about 120° C., such as greater than about 70° C. but less than about 100° C.. Additionally, the sample may be aged for about 1 hour or greater, such as about 4 hours or greater, such as about 6 hours or greater, such as about 8 hours or greater, such as about 10 hours or greater, such as about 12 hours or greater, such as about 14 hours or greater, such as about 16 hours or greater.

Calcination may be conducted at a variety of temperatures and for a variety of durations known to one of skill in the art. For example, calcination may be conducted at temperatures of from about 100° C. to about 800° C., such from about 200° C. to about 600° C., such as from about 300° C. to about 500° C.. Additionally, the sample may be calcined for about 1 hour or greater, such as about 4 hours or greater, such as about 6 hours or greater, such as about 8 hours or greater, such as about 10 hours or greater, such as about 12 hours or greater, such as about 14 hours or greater, such as about 16 hours or greater.

Calcining the sample yields a structure comprising a porous, heterostructure. The nanostructure comprises a plurality of pores, and has a distribution of nanoparticles consistent with a heterostructure. The plurality of pores produced during calcination are a result of the copolymer micelles being “burned out.” The nanoparticles remain in the same position relative to one another as prior to calcination, thus producing pores with different elemental distributions relative to the rest of the nanostructure matrix.

The pore size of the resulting calcined structures may additionally be controlled. For instance, the pore size of a calcined article as described herein may be about 5 nanometers or greater, such as about 10 nanometers or greater, such as about 15 nanometers or greater, such as about 25 nanometers or greater, such as about 35 nanometers or greater. Alternatively, the pore size may be controlled to be about 35 nanometers or less, such as about 25 nanometers or less, such as about 15 nanometers or less, such as about 10 nanometers or less, such as about 5 nanometers or less.

Reference will be now be made to the figures.

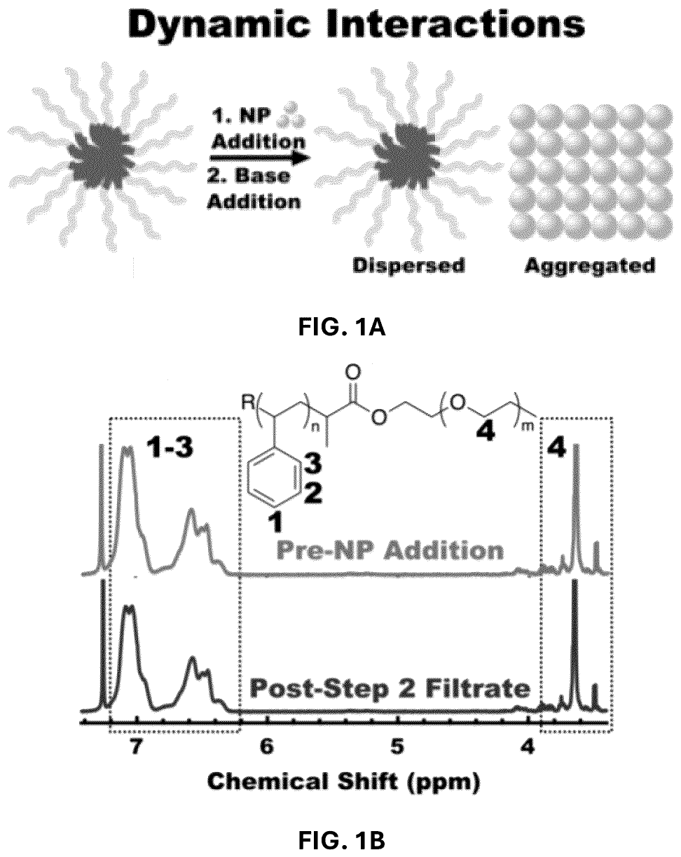

FIG. 1A is a depiction of dynamic micelle-nanoparticle interactions. Since nanoparticles are bound dynamically through weak intermolecular interactions, the addition of a base can cause the nanoparticles to aggregate, and leave the structure of the micelle, thus leaving a bare micelle with no entrained nanoparticles.

FIG. 1B is a graph depicting ¹H-NMR of a common block copolymer that dynamically interacts with nanoparticles via polyethylene oxide groups. The graph pre-nanoparticle addition shows a signal at about 3.7 ppm. After the nanoparticles are added, as well as a base to cause nanoparticle aggregation, the micelles are unbound to nanoparticles, and are able to pass through a filter as a filtrate, rather than remain as a precipitant with the nanoparticles. It was confirmed that the polyethylene oxide bearing block polymer passes through as a filtrate, as ¹H-NMR of the filtrate reveals the same chemical shift at 3.7 ppm found in the pre-nanoparticle addition block polymer.

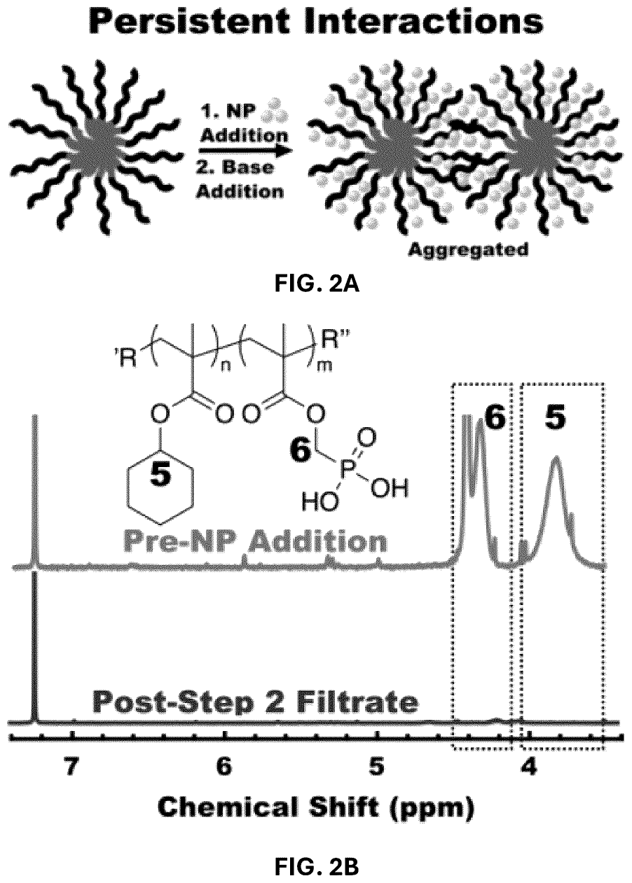

FIG. 2A is a depiction of persistent micelle-nanoparticle interactions. Since the nanoparticles are bound strongly through intramolecular bonds, such as covalent bonds, the addition of a base does not cause nanoparticles to leave the structure of the micelle. Rather, the nanoparticles form aggregates within the structure of adjacent micelles, forming a precipitate.

FIG. 2B, as with FIG. 1B, depicts an ¹H-NMR of an exemplary block copolymer which can form covalent bonds with nanoparticles. The ¹H-NMR spectrum pre-nanoparticle addition shows signals at 3.8 ppm and 4.2-4.4 ppm characteristics of a block copolymer bearing phosphinic acid groups. Nanoparticles are then added to the block copolymer solution, and a base is added thereafter to aggregate the nanoparticles. The sample is then filtered, and undergoes ¹H-NMR. In contrast with the spectrum of FIG. 1B, the post-filtration spectrum of FIG. 2B contains none of the signals associated with the phosphinic acid bearing block copolymer, indicating that the micelle remained persistently bound to the nanoparticles, and did not pass through as a filtrate.

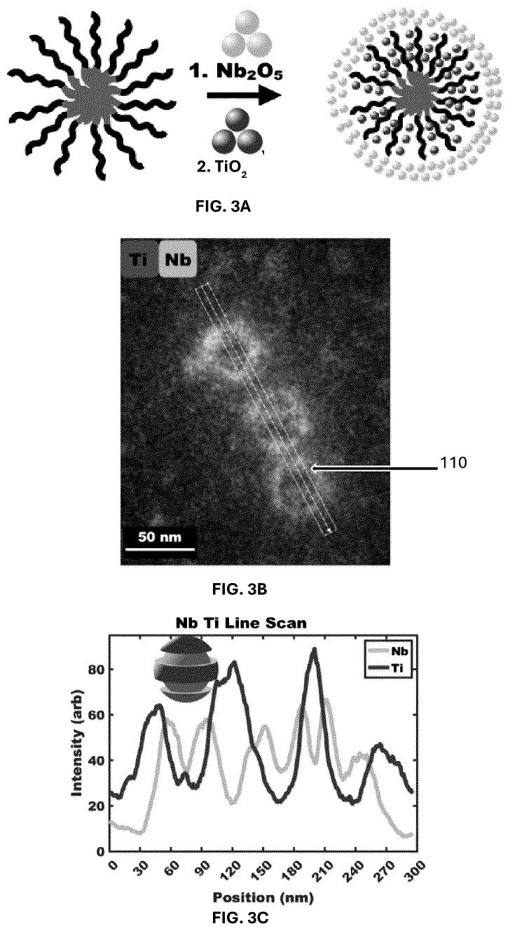

FIG. 3A is a depiction of the ordered addition of nanoparticles to a micelle. In the pictured embodiment, nanoparticles comprising niobium oxide are first added to the micelle. The first nanoparticles are covalently bound to the shell of the micelle. The second nanoparticles comprising titanium oxide are then added, forming a corona around the micelle.

FIG. 3B is an image generated from scanning transmission electron microscopy energy-dispersive X-ray spectroscopy showing the elemental distribution of a micelle with the structure described in FIG. 3A above. The lighter regions of the image represent niobium oxide, whereas the darker regions represent titanium oxide. As can be seen, the niobium oxide is largely confined to spherical regions where micelles were before calcination. Titanium oxide, on the other hand, is distributed throughout, and forms the bulk of the matrix. There is relatively little mixing between the niobium oxide and titanium oxide, indicating that the niobium oxide was persistently bound to the micelles.

The path 100 shown in FIG. 3B is represented by the composition line scan shown in FIG. 3C. Shown in FIG. 3C, titanium content is higher outside of pores, and low within pores. Contrastingly, niobium content is low outside of pores, and high on the inside of pores. Of note is the decrease in signal response for niobium at the middle of a pore region. This is a result of the 3-dimensional nature of pores.

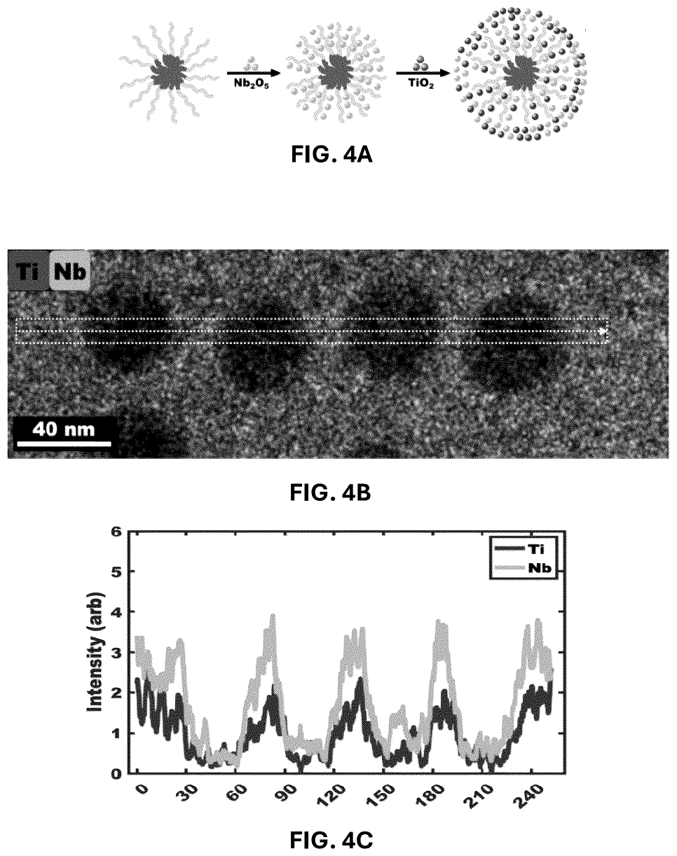

FIG. 4A is a schematic of a typical, dynamic binding polymer micelle after the addition of metal oxide nanoparticles. As can be seen by the elemental composition scan in FIGS. 4B and 4C, there is a homogenous elemental distribution.

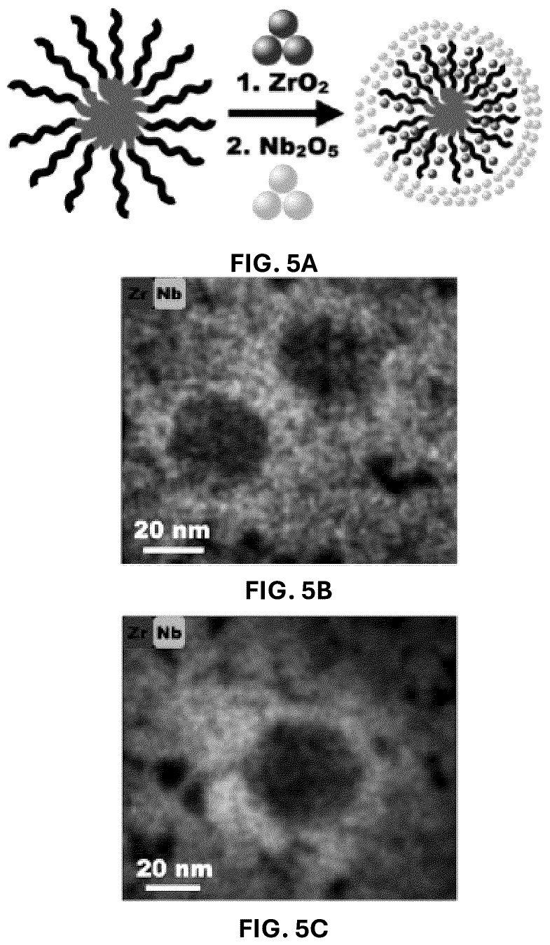

FIG. 5 illustrates a further embodiment of the present disclosure. As shown in FIG. 5A, two types of metal nanoparticles were sequentially added to block copolymer micelles. In this instance, zirconium oxide nanoparticles were first added. These nanoparticles became persistently bound within the shell of the block copolymer micelle. After the first nanoparticles became bound within the shell of the block copolymer micelle, the second metal nanoparticles were added. These second nanoparticles were niobium oxide and formed a corona around the block copolymer micelle. This sample was then dried, and calcined. A scanning transmission electron microscope was used with energy dispersive X-ray to produce images showing the elemental composition of the calcined sample. As can be seen by FIGS. 5B and 5C, the zirconium, which was added first, is largely limited to the inside of the pores left by removal of the block copolymer micelles, whereas the niobium is largely present in the matrix surrounding said pores.

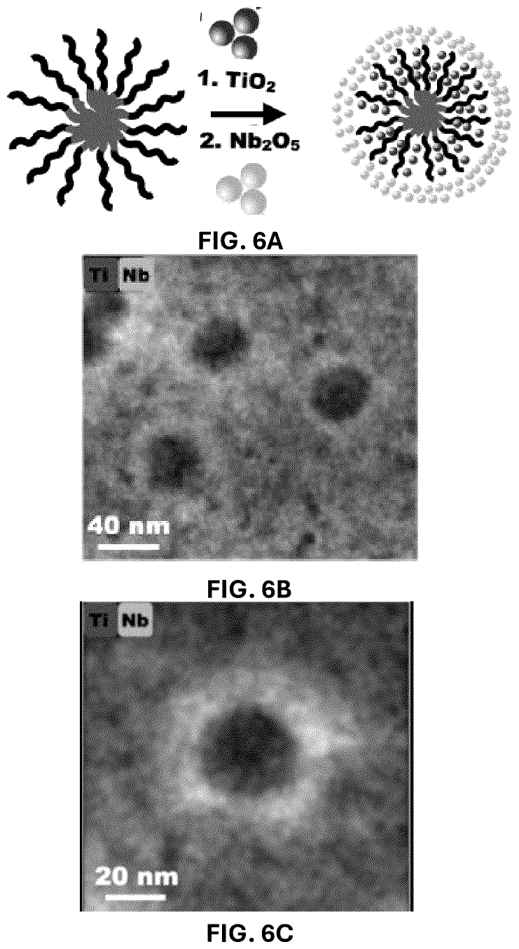

FIG. 6 is a further embodiment of the present disclosure. As shown in FIG. 6A, two types of metal nanoparticles were sequentially added to block copolymer micelles. In this instance, titanium oxide nanoparticles were first added. The titanium nanoparticles became persistently bound within the shell of the block copolymer micelle. After the titanium nanoparticles became bound within the shell of the block copolymer micelle, the second metal nanoparticles were added. These second nanoparticles were niobium oxide and formed a corona around the block copolymer micelle. This sample was then dried, and calcined. A scanning transmission electron microscope was used with energy dispersive X-ray to produce images showing the elemental composition of the calcined sample. As can be seen by FIGS. 6B and 6C, the titanium, which was added first, is largely limited to the inside of the pores left by the block copolymer micelles, whereas the niobium is largely present in the matrix surrounding said pores.

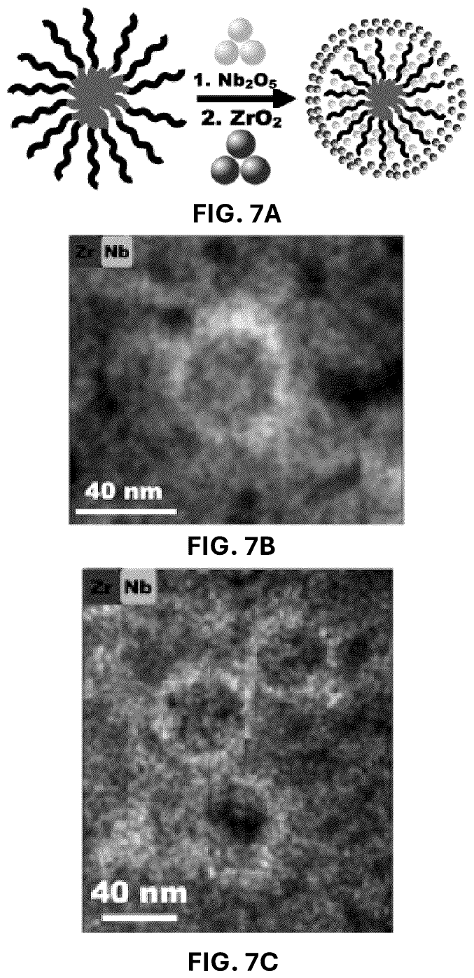

FIG. 7 is a further embodiment of the present disclosure. As shown in FIG. 7A, two types of metal nanoparticles were sequentially added to block copolymer micelles. In this instance, niobium oxide nanoparticles were first added. The niobium nanoparticles became persistently bound within the shell of the block copolymer micelle. After the niobium nanoparticles became bound within the shell of the block copolymer micelle, the second metal nanoparticles were added. These second nanoparticles were zirconium oxide and formed a corona around the block copolymer micelle. This sample was then dried, and calcined. A scanning transmission electron microscope was used with energy dispersive X-ray to produce images showing the elemental composition of the calcined sample. As can be seen by FIGS. 7B and 7C, the niobium, which was added first, is largely limited to the inside of the pores left by the block copolymer micelles, whereas the zirconium is largely present in the matrix surrounding said pores.

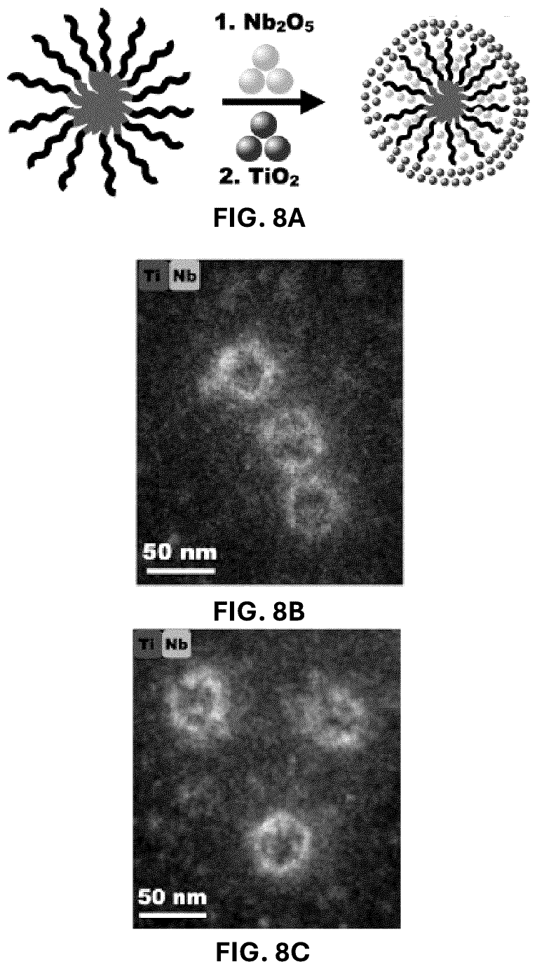

FIG. 8 is a further embodiment of the present disclosure. As shown in FIG. 8A, two types of metal nanoparticles were sequentially added to block copolymer micelles. In this instance, niobium oxide nanoparticles were first added. The niobium nanoparticles became persistently bound within the shell of the block copolymer micelle. After the niobium nanoparticles became bound within the shell of the block copolymer micelle, the second metal nanoparticles were added. These second nanoparticles were titanium oxide and formed a corona around the block copolymer micelle. This sample was then dried, and calcined. A scanning transmission electron microscope was used with energy dispersive X-ray to produce images showing the elemental composition of the calcined sample. As can be seen by FIGS. 8B and 8C, the niobium oxide, which was added first, is largely limited to the inside of the pores left by the block copolymer micelles, whereas the titanium oxide is largely present in the matrix surrounding said pores.

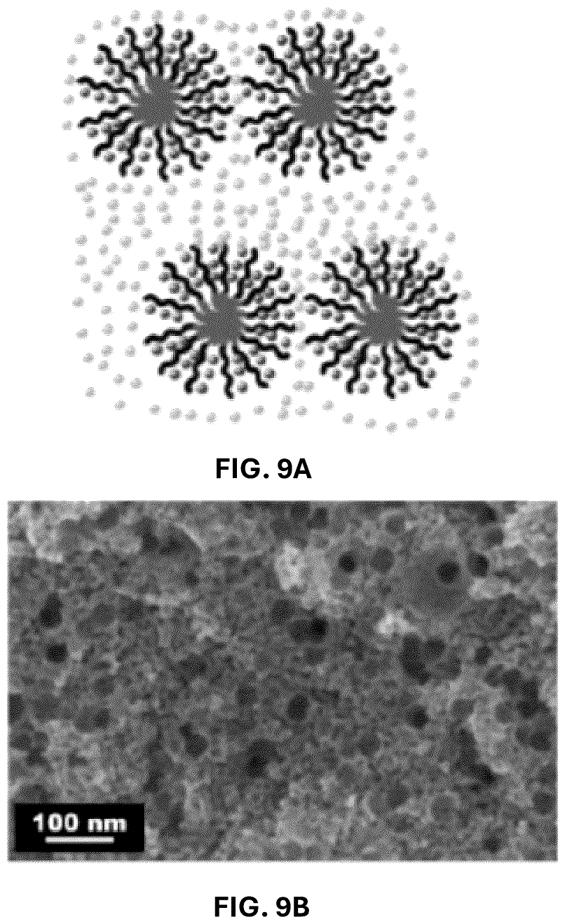

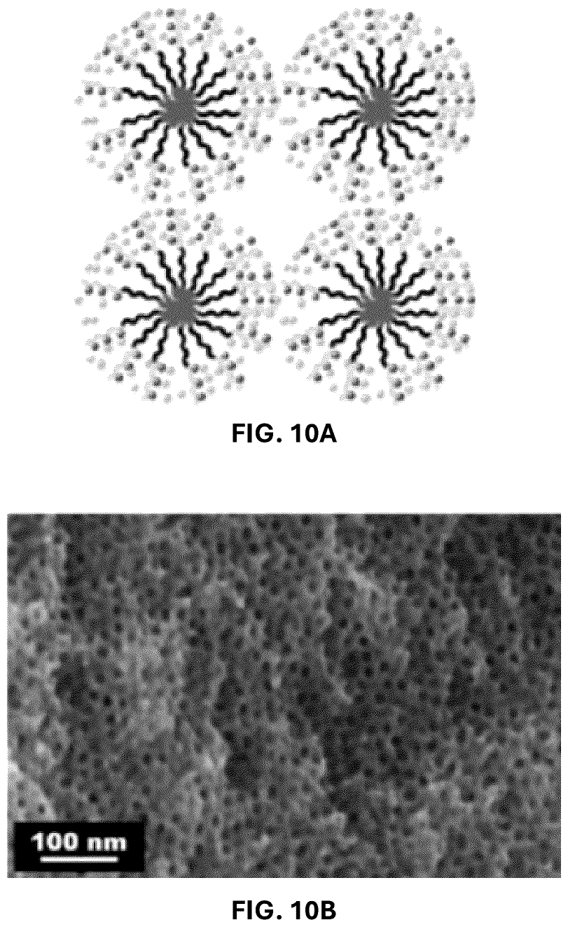

FIG. 9A is a schematic of a one embodiment of the structure created by nanoparticle-bound micelles. This structure may be characterized, at least in part, by micelles which form randomly distributed clusters. FIG. 9B is an SEM image of one such structure. As can be seen by the SEM image, as is predicted by the schematic of FIG. 10B, the structure comprises uneven clusters of pores (negatives of burned-out micelles).

FIG. 10A is schematic of another embodiment of the structure created by nanoparticle bound micelles. This structure can be characterized by a continuous network of pores. Without wishing to be limited by theory, it is believed that a terpolymer structure, that is a copolymer micelle comprising a triblock copolymer with an outermost block comprising a dynamic binding polymer, allows for increased uniformity of the structure. This can be seen in FIG. 10B, which is an SEM image taken of a structure resulting from a terpolymer-based micelle.

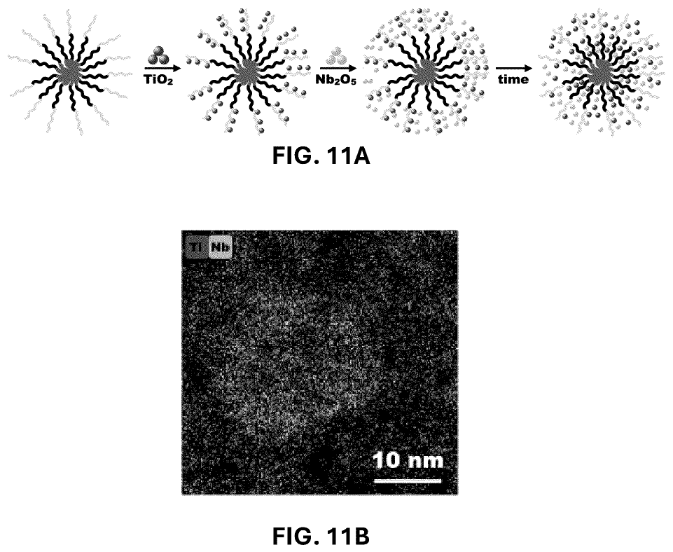

FIG. 11A is a schematic of the order of addition of nanoparticles to the terpolymer. In one embodiment, titanium oxide nanoparticles are added first to the terpolymer micelle. The titanium oxide nanoparticles remained dynamically bound on the outermost block of the terpolymer. Niobium oxide nanoparticles were added, at which point the titanium oxide and niobium oxide nanoparticles began to mix. After time was allowed to pass, both titanium oxide and niobium oxide nanoparticles infiltrated the inner shell of the micelle, becoming persistently bound to the micelle. FIG. 11B is a scanning transmission energy dispersive composition map, suggesting that there is a critical time for the first nanoparticles, in this case titanium oxide nanoparticles, to infiltrate the inner shell of the micelle.

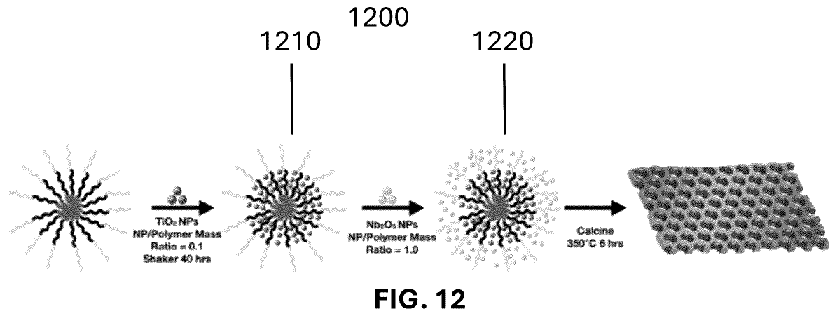

FIG. 12 is one embodiment of the present disclosure wherein the mixing of the first and second type of nanoparticles is not desired. The schematic depicts titanium oxide nanoparticles being added to a terpolymer micelle solution. Thereafter, the solution undergoes shaking for 40 hours. As seen at 1310, the titanium nanoparticles infiltrated the inner shell of the micelle. Niobium oxide nanoparticles are then added to the terpolymer micelle solution. Identifier 1320 shows the terpolymer micelle, with the titanium oxide nanoparticles, which were added first, fully infiltrating the inner shell of the micelle, and the niobium oxide remaining on the corona, or outer shell. The solution is then calcined to produce a porous macrostructure.

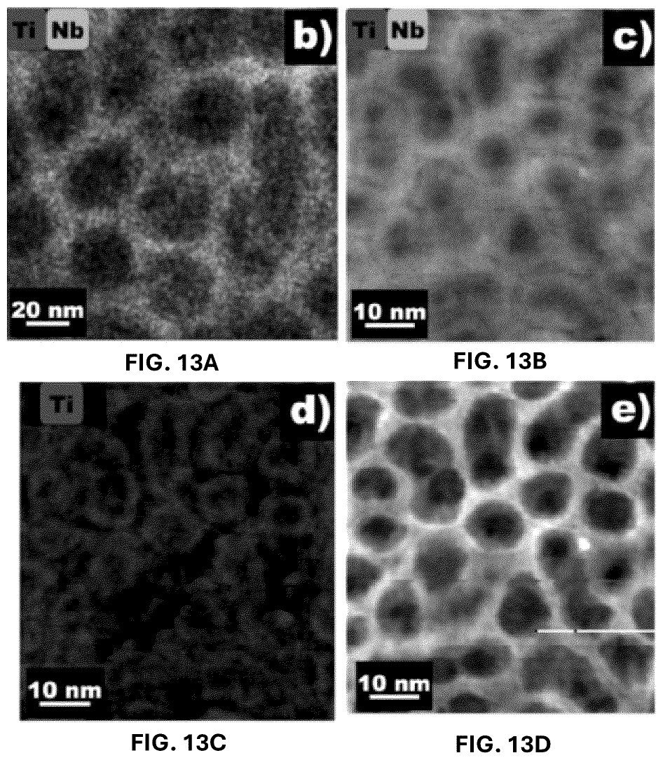

FIG. 13A through FIG. 13D are images from STEM energy-dispersive X-ray, STEM-electron energy loss spectroscopy and STEM high-angle annular dark-field. Each figure corroborates the porous and element-addition-ordered composition proposed by the schematic of FIG. 13.

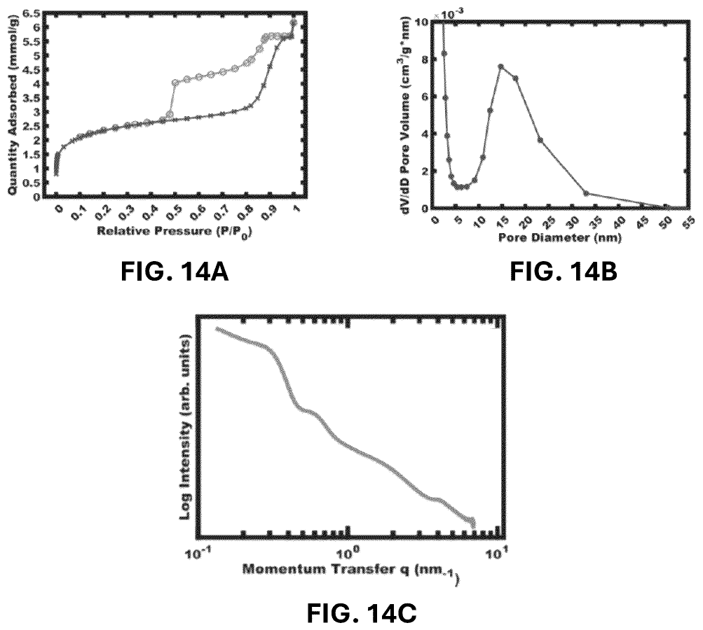

FIGS. 14A through 14C are graphs of nitrogen physisorption analysis. The porosity was characterized by the nitrogen physisorption isotherms where BET analysis indicated a high specific surface area of 189 m²/g and BJH analysis indicated ˜15 nm pore diameter. FIG. 14C is a graph generated by SAXS (small-angle x-ray scattering) confirming short-range pore ordering. SAXS measurements of PD-TiO2-Nb2O5-calcined exhibited structure factor peaks consistent with randomly packed spheres.

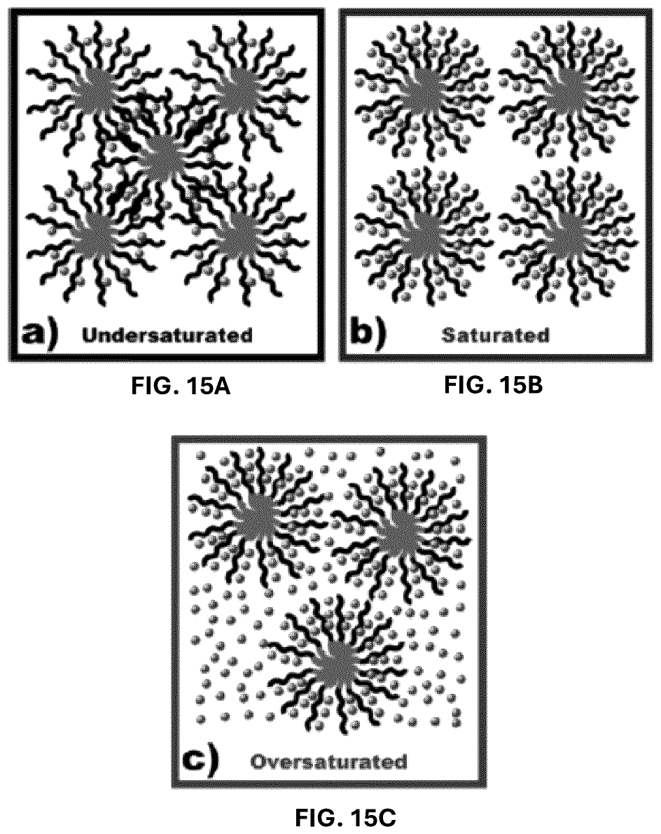

FIGS. 15A through 15C are schematics of the effect of nanoparticle concentration on micelle saturation. FIG. 15A is a schematic representing the case of a relatively low concentration of nanoparticles relative to the concentration of micelles. In this case, the micelles begin to overlap, as individual nanoparticles may become bound to multiple micelles. This leads to precipitation of the nanoparticle-micelles. FIG. 15B is a schematic representing the case where the concentration of nanoparticles is adequate to fully saturate the micelles. FIG. 15C is a schematic representing the case where the concentration of nanoparticles is high enough to saturate the micelles, as well as leave many nanoparticles unbound.

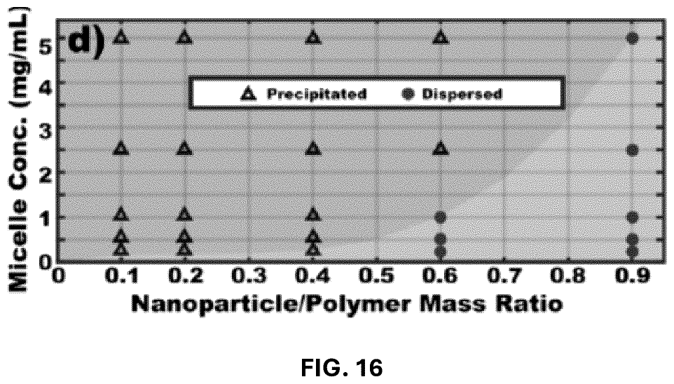

FIG. 16 is a graph showing the relationship between the micelle concentration and nanoparticle/polymer mass ratio. The triangles represent cases where the nanoparticle-micelles precipitate, indicating the ratio of nanoparticles to micelles is too low. The circles represent cases where the ratio of nanoparticle to micelles is such that the nanoparticle-micelles remain dispersed.

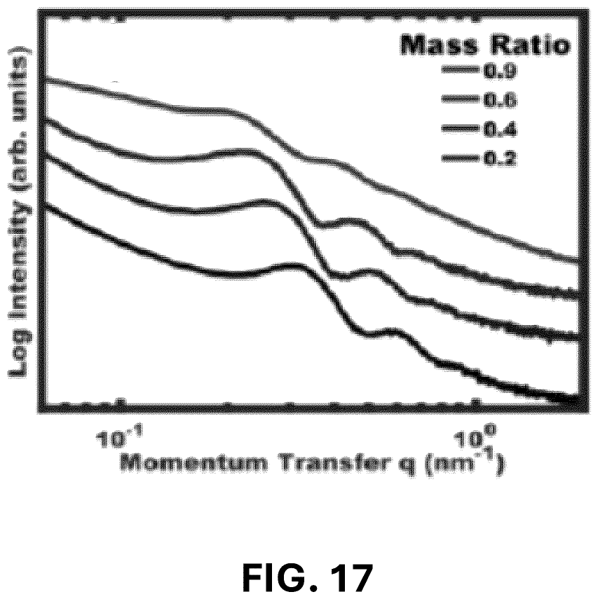

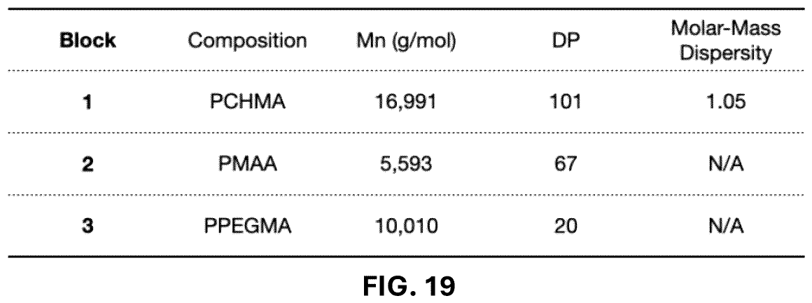

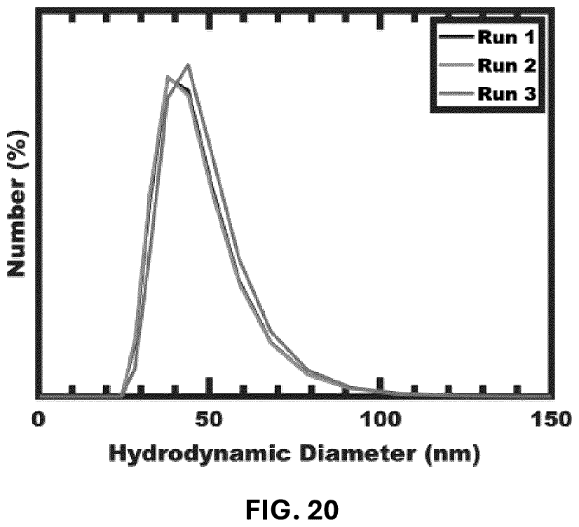

FIG. 17 is a graph generated by small angle X-ray scattering (SAXS) by analysis of the nanostructure created by the method shown in FIG. 20A. The graph shown in FIG. 19 confirms the short range pore ordering of the nanostructure.

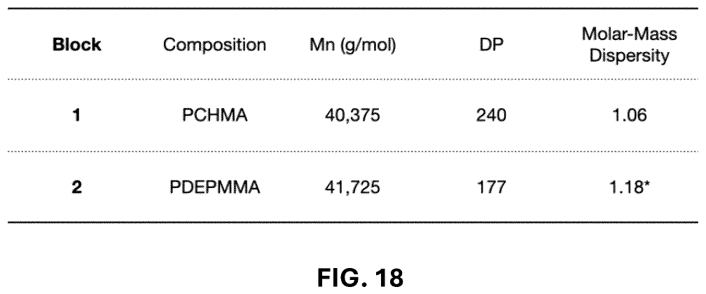

FIG. 18 contains summary data regarding the composition of a two-block copolymer micelle.

FIG. 19 contains summary data regarding the composition of an exemplary tri-block, or terpolymer, micelle.

FIG. 20 is a graph representing the % of two-block micelles with a specific hydrodynamic diameter.

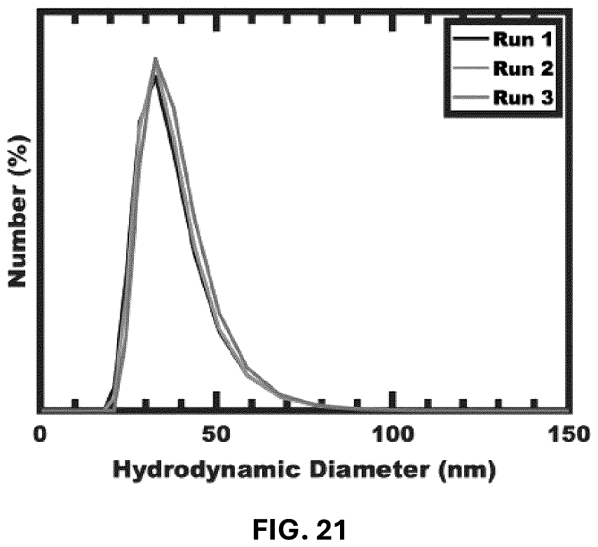

FIG. 21 is a graph representing the % of terpolymer micelles with a specific hydrodynamic diameter.

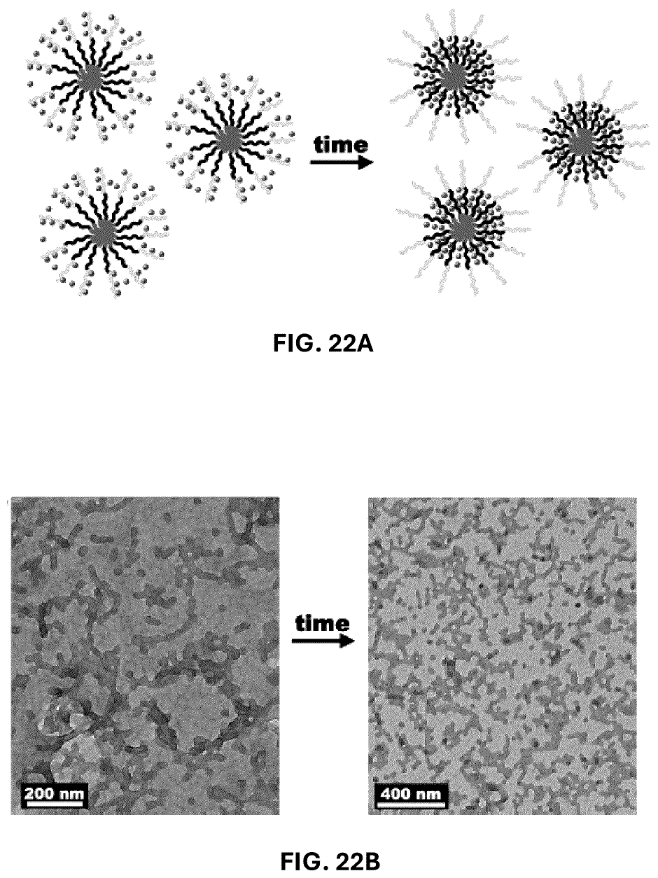

FIG. 22A is a schematic for the binding process of nanoparticles in micelles. As discussed previously, time is required after the first addition of nanoparticles to allow the first nanoparticle to become dynamically bound to the inner hydrophilic shell. Without wishing to be limited by theory, the difference in pore size (larger for samples calcined before nanoparticles are settled vs. smaller for samples calcined after nanoparticles are settled) is relative to how far the nanoparticles are from the core of the micelle. Thus, one means for reducing pore size is to allow the nanoparticles to settle into the inner hydrophilic shell. Alternatively, if larger pores are desired, one may calcine a sample before the nanoparticles are allowed to settle into the inner hydrophilic shell. FIG. 22B demonstrates this concept, showing that pore sizes are larger in the sample that was calcined before time was allowed to elapse as compared to pore sizes in the sample that was calcined after time had elapsed from the addition of the metal nanoparticles.

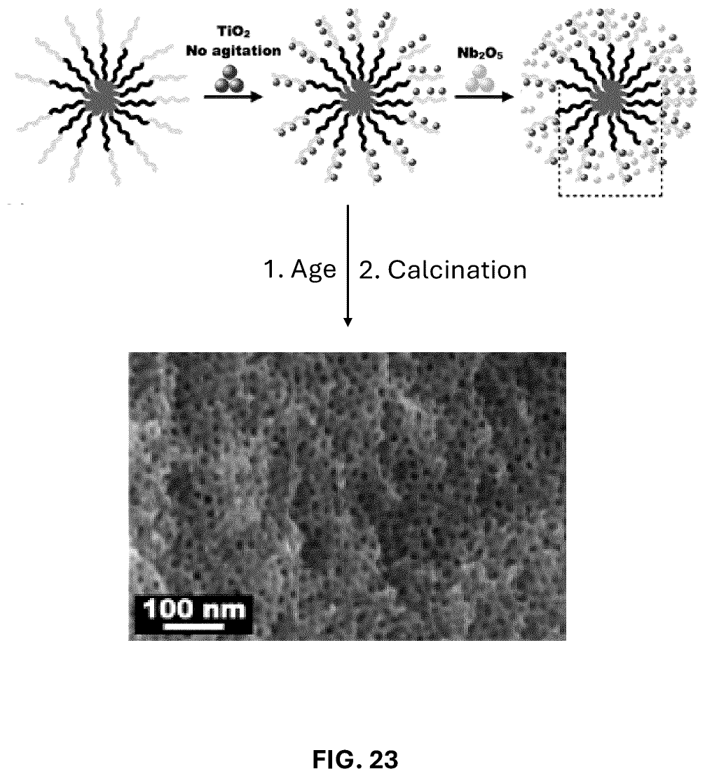

FIG. 23 shows the nanostructure that is created when the sample is calcined before nanoparticles become persistently bound to the micelle. The interpore distance are relatively large (27.4 nanometers).

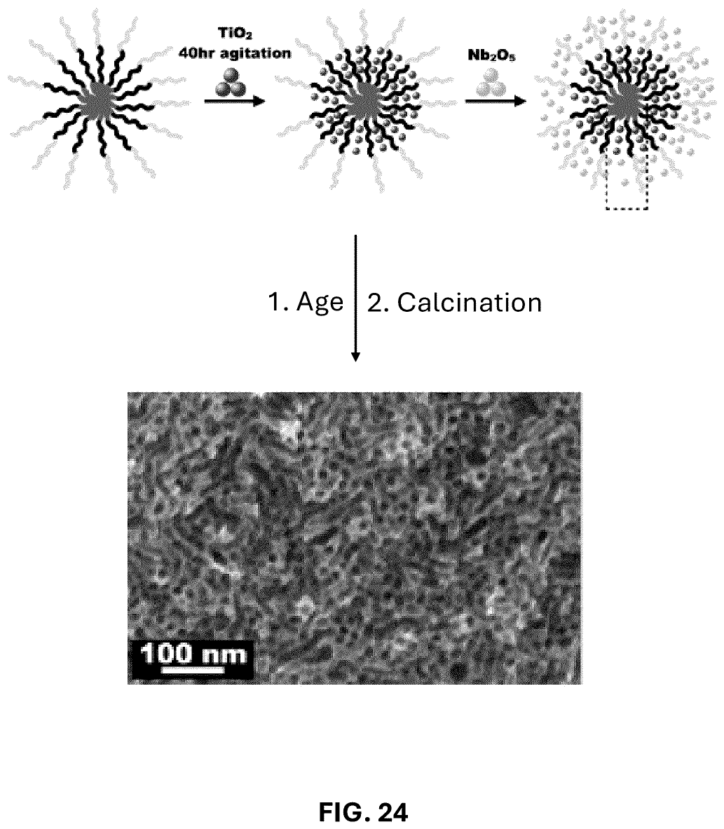

FIG. 24 shows the nanostructure that is created when the sample is calcined after the nanoparticles become persistently bound to the micelle. The interpore distances are relatively small (20.6 nanometers), as compared to the sample where the nanoparticles did not become dynamically bound.

The present invention may be better understood with reference to the examples, set forth below.

### Example 1: Synthesis of Micelles and Nanoparticle Solutions

As a non-limiting example of the present invention, the below Example is an embodiment of the synthesis and use of a variety of polymers suitable for use in the present disclosure.

DEPMMA was synthesized via a procedure described previously. Diethyl(hydroxymethyl)phosphonate (5 g, 4.27 mL, 29.73 mmol), methacrylic acid (2.56 g, 29.73 mmol), and 15 mL of chloroform were mixed in a round bottom flask. The solution was cooled to 0° C. and sparged with nitrogen for 30 min. A solution of N′N-dicyclohexylcarbodiimide (DCC) (6.75 g, 32.70 mmol), 4-dimethylaminopyridine (DMAP) (0.40 g, 3.27 mmol), and 5 mL of chloroform was then added in a dropwise manner. The suspension was left to vigorously stir at room temperature for 2 hrs. The suspension was then filtered and the chloroform was removed using reduced pressure. The crude product was then purified via vacuum distillation at 175° C.

Two separate PCHMA macro-initiators (40 k & 17 k) were synthesized, one for diblock synthesis and one for the triblock synthesis. The ratios of AIBN:4CPDB:CHMA for the diblock are outlined below. The triblock ratios were 0.1:1:101 and the same experimental procedures were as follows. Cyclohexyl methacrylate (CHMA) (7.50 mL, 42.95 mmol), 2,2′-azobis(2-methylpropionitrile) (AIBN) (8.80 mg, 0.027 mmol), 4-cyano-4-(phenylcarbonothioylthio)pentanoic acid (4CPDB) (100 mg, 0.18 mmol), and 4.50 mL of tetrahydrofuran (THF) were combined in a Schlenk flask and were subjected to three cycles of freeze-pump-thaw. The reaction flask was then brought into an argon-filled glovebox to backfill the flask with argon. The polymerization was then carried out in a preheated oil bath at 70° C. for 18 hrs. Once the polymerization was complete, the reaction was cooled in a freezer before venting and dilution with THE to fully dissolve the viscous product.

PCHMA was then precipitated using cold methanol, filtered, and then dried in a vacuum oven overnight. The molar mass of PCHMA was calculated based on the ratio of reversible addition-fragmentation chain-transfer (RAFT) agent to cyclohexyl methacrylate assuming 100% conversion.

PCHMA-4CPDB (˜40 k g/mol) macroinitiator (3.0 g, 0.07 mmol), 2,2′-azobis(2-methylpropionitrile) (AIBN) (3.66 mg, 0.023 mmol), DEPMMA (4.04 g, 4.29 mL, 17.09 mmol), and 10 mL of THE were mixed in a Schlenk flask and were subjected to three cycles of freeze-pump-thaw. The reaction flask was then brought into an argon-filled glovebox to backfill the flask with argon. The polymerization was then carried out in a preheated oil bath at 70° C. for 18.25 hrs. The reaction was then cooled in a freezer before venting and dilution with THF to fully dissolve the viscous product. PCHMA-b-PDEPMMA was then precipitated out using cold hexane, filtered, and then dried in a vacuum oven overnight.

PCHMA-4CPDB (˜17 k g/mol) macroinitiator (2.5 g, 0.15 mmol), 2,2′-azobis(2-methylpropionitrile) (AIBN) (3.62 mg, 0.023 mmol), methacrylic acid (0.84 g, 0.83 mL, 9.86 mmol) previously passed over a basic alumina column, and 8.53 mL of THF were mixed in a Schlenk flask and were subjected to three cycles of freeze-pump-thaw. The reaction flask was then brought into an argon-filled glovebox to backfill the flask with argon. The polymerization was then carried out in a preheated oil bath at 70° C. for 18.25 hrs. The reaction was then cooled in a freezer before venting and dilution with THF to fully dissolve the viscous product. PCHMA-b-PMAA was then precipitated out using cold hexane, filtered, and then dried in a vacuum oven overnight.

PCHMA-b-PMAA (˜23 k g/mol) macroinitiator (2.5 g, 0.11 mmol), AIBN (2.7 mg, 0.016 mmol), PEGMA (1.43 g, 1.48 mL, 2.86 mmol), and 15 mL of THF were mixed in a Schlenk flask and were subjected to three cycles of freeze-pump-thaw. The reaction flask was then brought into an argon-filled glovebox to backfill the flask with argon. The polymerization was then carried out in a preheated oil bath at 70° C. for 22 hrs. The reaction was then cooled in a freezer before venting and dilution with THF to fully dissolve the viscous product. PCHMA-b-PMAA-PPEGMA was then precipitated out using cold hexane, filtered, and then dried in a vacuum oven overnight.

PCHMA-b-PMAA-b-PPEGMA (˜33 k g/mol) (3 g, 0.09 mmol) and diethyl(hydroxymethyl)phosphonate (2 g, 11.90 mmol) were dispersed in 20 mL of THF. A separate solution of DCC (2.7 g, 13.08 mmol) and DMAP (160 mg, 1.31 mmol) were dispersed in 10 mL of THF. The DCC/DMAP suspension was added dropwise to the polymer solution and stirred at room temperature overnight. The final product was separated via dialysis against THF and the solvent was removed by evaporation.

The phosphonated ester functionality of both the PCHMA-b-PDEPMMA and PCHMA-b-PDEPMMA-b-PPEGMA polymers were converted to phosphonic acid via the Mckenna reaction. Complete removal of the esters is feasible as previously demonstrated. In general the polymer was dispersed in a 50/50 (v/v) solution of THF/acetonitrile at a concentration of 100 mg/mL and TMSBr was added dropwise to the solution. A ratio of 6:1 of TMSBr(mol):Phosphonates(mol) was used where the degree of polymerization and two esters per repeat unit must be considered. The solution was then allowed to stir at 50° C. overnight. The intermediate product was isolated by the removal of the solvent via evaporation and the polymer was dispersed in a 50/50 (v/v) solution of methylene chloride/methanol at 100 mg/mL.

Concentrated HCl (0.36 mL) was added to 2 mL of methanol. While stirring at 300 rpm TTIP (1.2 mL 4.05 mmol) was added rapidly. The solution was then diluted with 11 mL of dry methanol. The final concentration of TiO₂ was calculated to be 22.53 mg/mL.

Concentrated HCl (0.113 mL) was dispersed in 3 mL of dry methanol. While stirring at 300 rpm NbEtOH (0.3 mL, 1.19 mmol) was added rapidly. The final concentration of Nb2O5 was calculated to be 91.63 mg/mL.

Concentrated HCl (3 mL) was dispersed in 10 mL methanol. While stirring at 300 rpm 1.4 mL of zirconium(IV) butoxide (≥80% w/w in 1-butanol) was added rapidly. The final concentration of ZrO₂ was calculated to be 25.65 mg/mL.

### Example 2

The micelle-nanoparticle interactions for two micelles were examined with binding experiments. The first example pertains to the separation of micelles from nanoparticles. An excess of acid-stabilized TiO₂ nanoparticles were added to either solutions of PMMPA or PEO micelles. Subsequently, base addition induced nanoparticle-aggregation and precipitation. The solutions were filtered to remove the nanoparticle precipitant, the solvent was evaporated from the filtrate and any residue was dispersed in CDCL₃ for ¹H-NMR. The observation of PEO or PMMPA in this final solution would identify that it was not persistently attached to the nanoparticles. The NMR spectrums of the PMMPA and PEO are shown in FIGS. 1B and 2B.

As found in FIG. 1B, corresponding to the dynamically binding micelle comprising PEO, the dynamically binding micelle was present in the filtrate. As is shown in FIG. 2B, the PCHMA-b-PMMPA was not present in the filtrate after nanoparticle-aggregation and precipitation.

These results indicate that the PCHMA-b-PMMPA was persistently bound to the nanoparticles, and precipitated out with the bulk of the nanoparticles, while the PS-b-PEO was bound only dynamically, such as through dipole interactions as discussed above, and passed through as filtrate. While not intending to be limited by theory, it is believed that the presence of the phosphonate groups on the PCHMA-b-PMMPA micelles are covalently linked to the nanoparticles, preventing PCHMA-b-PMMPA micelles from entering the filtrate.

While certain embodiments of the disclosed subject matter have been described using specific terms, such description is for illustrative purposes only, and it is to be understood that changes and variations may be made without departing from the spirit or scope of the subject matter.

What is claimed is:

1. A method for producing an inorganic heterostructure comprising:
forming a solution comprising block copolymer micelles;
adding first metal oxide nanoparticles to the solution, wherein upon the addition, functional groups of the block copolymer micelles react with the first metal oxide nanoparticles to covalently bond the first metal oxide nanoparticles to the block copolymer micelles; and
adding second metal oxide nanoparticles to the solution.

2. The method of claim 1, wherein the block copolymer micelles comprise a hydrophobic core comprising a first polymer and a hydrophilic shell comprising a second polymer.

3. The method of claim 2, wherein the hydrophilic shell further comprises a third polymer.

4. The method of claim 2, wherein the first polymer comprises polystyrene or poly(cyclohexyl methacrylate).

5. The method of claim 2, wherein the second polymer comprises methacryloyloxymethyl phosphonic acid.

6. The method of claim 3, wherein the third polymer comprises poly(ethylene glycol) methacrylate.

7. The method of claim 2, wherein the first and second polymers each independently have a molecular weight greater than about 35,000 g/mol.

8. The method of claim 1, wherein the first and second metal oxide nanoparticles are selected from the group consisting of titanium oxide nanoparticles, zirconium oxide nanoparticles and niobium oxide nanoparticles.

9. The method of claim 1, wherein the second metal oxide nanoparticles are added to the block copolymer micelles after a duration of time following the addition of the first metal oxide nanoparticles.

10. The method of claim 9, wherein the block copolymer micelles undergo agitation during the duration of time.

11. The method of claim 1, wherein the functional groups capable of forming covalent bonds with the first metal oxide nanoparticles comprise phosphonic acids, silanes, acetylacetonates and carboxylates.

12. The method of claim 1, further comprising evaporating the solution.

13. The method of claim 12, further comprising removing the block copolymer micelles by calcination.

14. The method of claim 12, further comprising removing the block copolymer micelles with chemicals.

15. The method of claim 9, wherein the duration of time is about 20 hours or greater.
